(19) United States
(12) Patent Application Publication
(10) Pub. No.: US 2006/0281622 A1
(43) Pub. Date: Dec. 14, 2006

(54) Mineral fibre-based product, device for the production of said fibres and production method thereof

(75) Inventors: Jean-Pierre Maricourt, Avignon (FR); Daniel Guyot, Rantigny (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SAINT-GOBAIN ISOLVER, Courbevoie (FR)

(21) Appl. No.: 10/555,219

(22) PCT Filed: May 7, 2004
(86) PCT No.: PCT/FR04/01109

§ 371 Date: Nov. 3, 2005

(30) Foreign Application Priority Data
May 7, 2003 (FR) 0305564

(51) Int. Cl. C03C 13/06; E04B 1/74; C03B 37/04; C03B 37/022; F27B 7/00

(52) U.S. Cl. 501/36; 252/62; 65/470; 65/504; 65/523

(57) ABSTRACT

Thermal and/or acoustic insulation product based on mineral fibers, obtained by internal centrifugation and attenuation by a high-temperature gas stream and by crimping, characterized in that it contains no devitrified and/or defiberized particles, the length of the fibers is at most equal to 2 cm, preferably less than 1.5 cm, and the fibers have a micronaire per 5 grams of less than or equal to 4, especially between 2.5 and 4, or a micronaire of less than or equal to 18 l/mim, especially between 11 and 15 l/mim, in particular around 12 to 13 l/mim.

The invention relates to products based on mineral fibers, such as glass wool, which are intended to be used, for example, in the composition of thermal and/or acoustic insulation products.

These products are obtained by an internal centrifugation process combined with attenuation by a high-temperature gas stream.

This process for forming fibers consists, in a known manner, in introducing a stream of molten glass into a spinner, also called a fiberizing dish, rotating at high speed and drilled around its periphery by a very large number of holes through which the glass is thrown out in the form of filaments owing to the effect of the centrifugal force. These filaments are then subjected to the action of a high-temperature high-velocity annular attenuation stream that hugs the wall of the spinner, which stream attenuates the filaments and converts them into fibers. The fibers formed are entrained by this attenuating gas stream toward a receiving device, generally consisting of a gas-permeable belt.

The invention involves more particularly, but not however restrictingly, thermal and/or acoustic insulation products having particularly high mechanical properties for specific applications requiring such properties. These are especially insulation products in the form of felts that are suitable for supporting masonry elements and consequently have to withstand high compressive loads, such as elements used for the insulation of flat roofs that can be walked upon. This is also the case for products that are used as outdoor insulation and must be able, in particular, to withstand tear forces.

To achieve such a performance, this type of insulation product generally has a high density, for example at least 40 kg/m³, and has undergone, after the actual fiberizing operation, an operation aimed at making the fibers inside the felt adopt directions as varied as possible without substantially modifying too much the overall orientation of the web of fibers resulting from the centrifugation. This operation consists especially in “crimping” the fibers, by passing the web of fibers between two series of conveyors that define its upper and lower faces, a longitudinal compression resulting from the passage from one pair of conveyors driven at a certain speed to a pair of conveyors driven at a speed slower than the previous speed. This type of operation is for example described in patent EP-0 133 083.

However, it has been found that this crimping operation does not always allow the expected improvement in the mechanical properties to be achieved.

The object of the published patent application WO 01/38245 is specifically to improve the mechanical properties of thermal and/or acoustic insulation products (or at the very least to ensure better constancy of these properties from one product to another), without thereby degrading the insulation properties, by more particularly concentrating on high-density insulation products that have undergone a crimping operation.

Instead of seeking to modify the parameters of the usual crimping process, that document examines the reasons for which such crimping is not always satisfactory. It came to the conclusion that, after crimping, it happens that the fibers are not as sufficiently oriented isotropically as hoped for, this being due to the fact that in particular their dimensions are not necessarily the most suitable: excessively long fibers are difficult to reorient by simple crimping as randomly as is necessary to ensure the best tear strength and compressive strength.

The object of that document therefore consisted in modifying the fiberizing conditions in order to adjust the dimensions of the fibers so that they are better suited for crimping, especially by making them shorter.

Conventionally, a device of the prior art for forming mineral fibers by internal centrifugation comprises:
a spinner capable of rotating about an axis, especially a vertical axis, and the peripheral band of which is pierced by a number of holes;
a high-temperature gas attenuation means in the form of an annular burner;
a pneumatic means for channeling/adjusting the dimensions of the fibers in the form of a blowing ring.

In fact, schematically, the sheet of gas produced by the pneumatic means that the blowing ring forms does not constitute an “impermeable” pneumatic barrier in the sense that all or some of the fibers are subject to a centrifugal force sufficient for them to pass through said barrier. On the other hand, this pneumatic barrier does slow them down, possibly inflecting the direction of their movement; but it also acts on their dimensions—when the fibers strike the sheet of cold gas, the resulting shock is sufficiently strong for the fibers to be possibly broken.

This is therefore a known means for controlling the length of the fibers. However, this turned out to be insufficient for truly obtaining a sufficiently short fiber length to permit crimping under optimum conditions without thereby compromising their insulation capacity.

Thus, the cited document WO 01/38245 has modified the way in which the fibers that have undergone the hot-gas attenuation are channeled using a standard device of the prior art.

Thus, that document provides, apart from said pneumatic means, another means consisting of a mechanical means comprising a cooled wall placed around the spinner facing at least its peripheral band.

The additional mechanical means recommended by that document has been shown to be very effective for supplementing the action of the blowing ring and for providing more options for controlling the size of the fibers. What is therefore involved here is to add, to the pneumatic barrier formed by the blowing ring, another barrier, this time a mechanical barrier, placed around the spinner beyond the pneumatic barrier, which too has two roles to perform: firstly, it channels all the fibers, all those that have already been able to pass through the pneumatic first barrier, beneath the fiber-receiving member, and then it allows the length of the collected fibers to be more finely adjusted: the impacts of these fibers against the physical wall allow them to be shortened very effectively in order to obtain optimum crimping. Furthermore, this wall is cooled, so that there is no risk of the fibers that come into contact with it, which are still relatively hot, sticking thereto.

However, the addition of this mechanical means formed by the annular wall placed in proximity to and along the axis of the spinner prevents the fitting around the latter of an annular inductor through which an electric current flows, such an inductor being well known in the prior art, which, when present, makes it possible to provide induction heating of the bottom of the band of the spinner's peripheral wall, which has a tendency to cool. This cooling is also accentuated by the addition of the cooled wall.

Consequently, the device of the cited document, which does not have an annular inductor and uses a cooled annular wall, has the drawback of having a band bottom that cools, and this has the tendency over time of making it difficult for the filaments to pass through the lower holes in the spinner, ending up with no longer producing filaments but defiberized and/or devitrified particles, and even leading to the holes becoming blocked. Trials have shown that this phenomenon is marginal when the aim is to produce “large diameter” fibers, especially with diameters of around 10 μm as in the cited document, but it is accentuated very substantially when the aim is to obtain finer fibers, especially with a diameter of less than about 6 μm.

In addition, the end-product in this cited document, sold in particular by Saint-Gobain Isover under the name LITOBAC, admittedly has shorter fibers than those usually obtained, but with the possible presence of devitrified grains or particles, which may affect its mechanical properties (compressive strength and tear strength) and thermal properties.

Furthermore, this product based on shorter fibers has relatively coarse fibers, of the order of 10 μm in diameter, and more precisely with a micronaire per 5 grams of 6.8. Now, this coarseness of fiber results in a product that is rough to touch, making it rather uncomfortable to handle. It will be recorded that the fineness of fibers is determined by the value of their micronaire (F) per 5 g. The measurement of the micronaire, also called the “fineness index”, takes account of the specific surface area thanks to the measurement of the aerodynamic pressure loss when a given quantity of fiber extracted from an unsized blanket is subjected to a given pressure of a gas—generally air or nitrogen. This measurement is standard practice in mineral fiber production units—it is standardized (DIN 53941 or ASTM D 1448) and uses what is called a “micronaire instrument”.

The object of the invention is therefore to provide a thermal and/or acoustic insulation product obtained from mineral wool produced by internal centrifugation and attenuation by a high-temperature gas stream, and by crimping, which, without having the drawbacks of the prior art, improves its tear strength and compressive strength properties.

According to the invention, the product is characterized in that it contains no devitrified and/or defiberized particles, the length of the fibers is at most equal to 2 cm, preferably less than 1.5 cm, and the fibers have a micronaire per 5 grams of less than or equal to 4, especially between 2.5 and 4, or a micronaire of less than or equal to 18 l/mim, especially between 11 and 15 l/mim, in particular around 12 to 13 l/mim.

Within the meaning of the invention, the length of the fibers is defined by measuring the length of a tuft of fibers, removed in particular using tweezers and weighing between 0.5 and 1 gram, from a specimen of product containing no binder, i.e. either a product removed directly from beneath the spinner, or an unsized product.

Within the context of the invention, a product “that contains no devitrified and/or defiberized particles” is understood to mean a product having less than 1% by weight of particles with an apparent particle diameter of greater than 40 μm (for example particles in the form of droplets).

Thus, the product of the invention has, owing to its shorter fibers, the advantage of resulting in good tear strength and compressive strength properties, because of a low fiber micronaire, a more useful (lower) thermal conductivity than that of the LITOBAC-type product and a more pleasant and softer feel of the product than that of the LITOBAC-type product.

For information, it may be noted that there is a correspondence relationship between the micronaire value thus obtained within the context of the invention and the value of the mean diameter of the fibers in the specimen. In general, a micronaire value of about 12 l/mim corresponds to a mean diameter of 2.5 to 3 μm, a value of 13.5 l/mim corresponds approximately to a mean diameter of 3 to 3.5 μm and finally 18 l/mim corresponds to about 4 to 5 μm.

According to one feature, the product has a density at least equal to 40 kg/m³, especially between 60 and 200 kg/m³, or even equal to or greater than 80 kg/m³, in particular less than 120 kg/m³.

According to another feature, it is obtained from internal centrifugation by flow of molten glass in a basket provided with holes from which primary streams are expelled toward the peripheral band of a spinner, which spinner also has holes from which filaments are expelled, these expelled filaments being attenuated by high-temperature gases emitted from the outlet of a burner at a temperature of at least 1500° C., preferably at least 1600° C. and especially between 1500 and 1650° C.

Advantageously, the product is obtained by attenuating filaments, these being expelled from a spinner, in a high-temperature gas stream that is emitted from the outlet of a burner at a pressure of at least 600 mm of WC, preferably in the region of 650 mm of WC.

It may also be obtained by means of internal centrifugation by flow of molten glass in a basket provided with holes from which primary streams are expelled toward the peripheral band of a spinner, which also has holes from which filaments are expelled, the bottom of the basket being substantially at the height of the lowest part of the spinner.

According to another feature, the product obtained by the above methods of implementation is derived from the filaments expelled from the spinner and channeled using a pneumatic means, of the gas jet type, so as to produce fibers which in turn are also channeled and adjusted lengthwise using a mechanical means, of the wall type, which is struck by the fibers.

According to another feature, the product is obtained from glass compositions described in patent applications EP 0 399 320 and EP 0 412 878, or else in patent application WO 00/17117.

Thus, mention may be made of the following glass compositions (in proportions by weight):

| SiO₂ | 57 to 70% |
|---|---|
| Al₂O₃ | 0 to 5% |
| CaO | 5 to 10% |
| MgO | 0 to 5% |
| Na₂O + K₂O | 13 to 18% |
| B₂O₃ | 2 to 12% |
| F | 0 to 1.5% |
| P₂O₅ | 0 to 4% |
| Impurities | <2% |

and contains more than 0.1% by weight of phosphorus pentoxide when the weight percentage of alumina is equal to or greater than 1%.

Or as another composition, in mol %:

| | |
|---|---|
| SiO₂ | 55-70 |
| B₂O₃ | 0-5 |
| Al₂O₃ | 0-3 |
| TiO₂ | 0-6 |
| Iron oxides | 0-2 |
| MgO | 0-5 |
| CaO | 8-24 |
| Na₂O | 10-20 |
| K₂O | 0-5 |
| Fluoride | 0-2 |

Or else, the following glass composition (in proportions by weight), the alumina content preferably being greater than or equal to 16 wt %:

| | |
|---|---|
| SiO₂ | 35-60% |
| Al₂O₃ | 12-27% |
| CaO | 0-35% |
| MgO | 0-30%, |
| Na₂O | 0-17% |
| K₂O | 0-17% |
| R₂O (Na₂O + K₂O) | 10-17%, |
| P₂O₅ | 0-5% |
| Fe₂O₃ | 0-20% |
| B₂O₃ | 0-8% |
| TiO₂ | 0-3% |

Advantageously, it is used to manufacture roof panels with a density of between 80 and 150 kg/m³, a binder content of around 10% and having a tear strength after ageing of at least 20 kPa and a compressive strength of about 70 kPa for a thickness of about 50 mm or at least 55 kPa for a thickness of about 80 mm, and also a thermal conductivity of at most 35 mW/m·K.

The invention also relates to, in particular for manufacturing the product of the invention, a device for forming mineral fibers by internal centrifugation, comprising:
a spinner capable of rotating about an axis X, especially a vertical axis, and the peripheral band of which is drilled with a number of holes;
a basket with associated bottom inside the spinner;
a high-temperature gas attenuation means in the form of an annular burner;
a pneumatic means for channeling/adjusting the dimensions of the fibers, in the form of a blowing ring;

which device is characterized in that it includes a mechanical means comprising a wall placed around the spinner, opposite at least its peripheral band, and the bottom of the basket is substantially at the height of the lowest part of the peripheral band of the spinner using means for lowering the basket or distancing it from the upper part of the spinner.

These lowering or distancing means consist especially of a chock associated, on the one hand, with the basket and, on the other hand, with the upper part of the spinner.

According to another feature, the wall is cooled and is at least partly cylindrical or in the form of a truncated cone preferably flared out at the top.

Preferably, the temperature of the burner in this device is at least 1500° C., preferably at least 1600° C., and the pressure of the burner is at least 600 mm of WC, preferably about 650 mm of WC.

The invention also relates to a process for forming mineral fibers in order to obtain a thermal and/or acoustic insulation product. This process, which comprises an internal centrifugation operation by means of a spinner in which molten glass flows and from which filaments are expelled, by high-temperature gas attenuation by means of an attenuating gas stream emitted by a burner and through which the filaments are converted into fibers, and by crimping, is characterized in that the temperature of the burner and/or its pressure are/is adjusted according to the temperature of the molten glass.

This regulation makes it possible to obtain fibers that are short, with a length of at most 2 cm, and are fine, having a micronaire per 5 g of at most 4, or at most 18 l/mim.

The temperature of the burner must be at least 1500° C., preferably 1600° C., and the pressure of the burner must be at least 600 mm of WC, preferably about 650 mm of WC.

In this process, the fibers may furthermore be channeled using a pneumatic means, of the gas jet type, and be adjusted lengthwise using a mechanical means, of the wall type, which are struck by the fibers.

It is also possible for the filaments expelled from the spinner to be obtained from a spinner, the bottom of the basket of which has been lowered so as to be approximately at the height of the lowest part of the spinner.

It may also be advantageous to increase the number of holes per unit area of the spinner compared with the number of holes of an existing spinner.

Other advantages and features of the invention will now be described in greater detail with regard to the appended drawings in which:

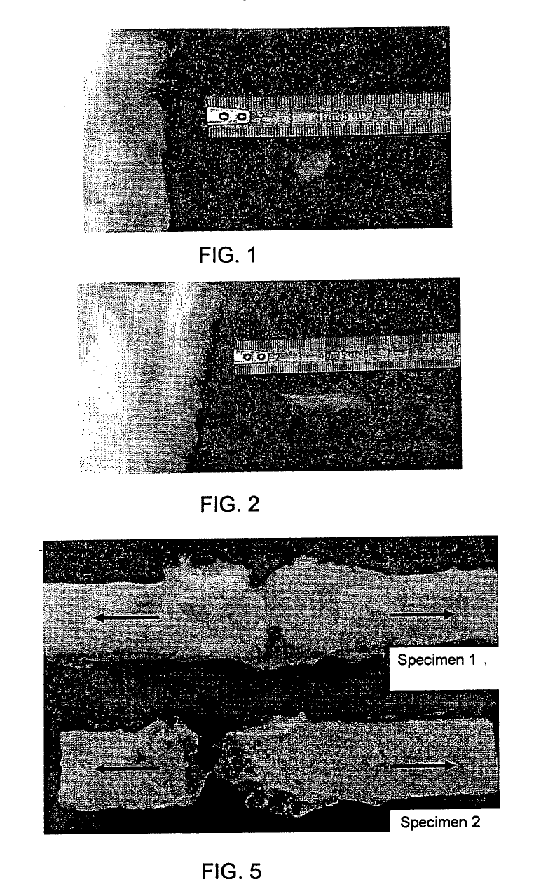

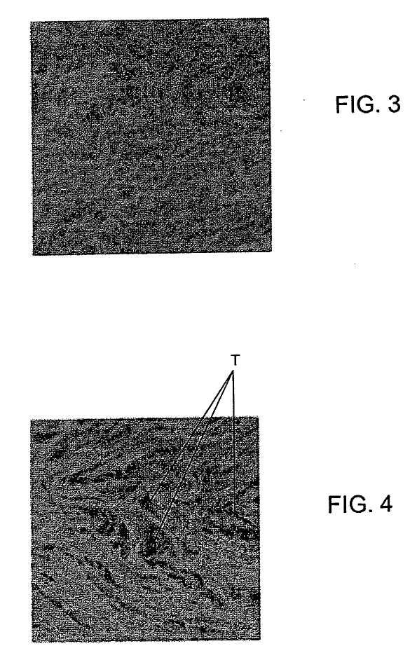

FIGS. 1 and 3 are photographs of partial views of a product of the invention;

FIGS. 2 and 4 are photographs of partial views of a product of the prior art;

FIG. 5 is a photograph of the product of the invention and of a product of the prior art, both torn in the same direction;

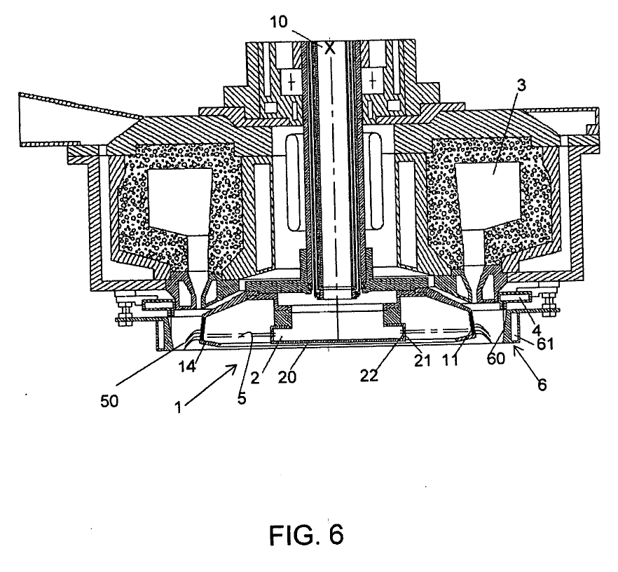

FIG. 6 is a schematic view in vertical section of the fiberizing device according to the invention; and

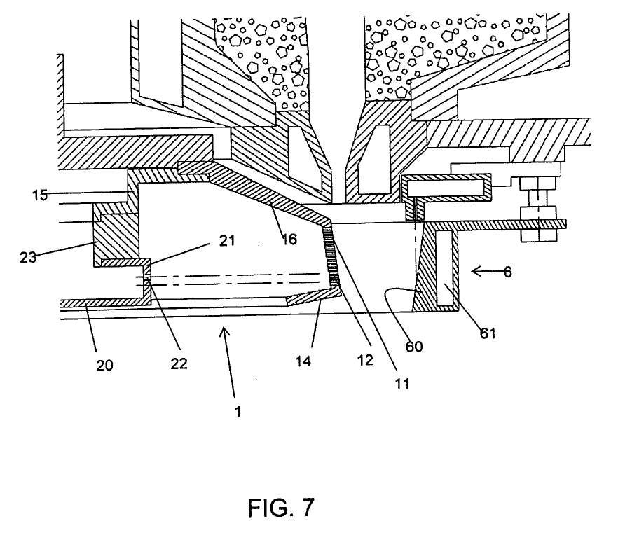

FIG. 7 is an enlarged partial view of FIG. 6.

The photographs 1 and 2 show the difference in length of the fibers between the product of the invention and the usual one of the prior art.

The fibers were removed from mineral wool products, in this case glass wool products, that were obtained by internal centrifugation and attenuation by a high-temperature gas stream, and by crimping, using fiberizing and crimping installations that we will describe later.

The products tested were 20 cm×20 cm specimens with a thickness of 50 mm, cut from larger felts. The dimensions of the specimens are given by way of example for the present tests, but they may, of course, be different without the desizing step, that we will describe below and that precedes the removal of the fibers, being changed.

These products had a density of at least 40 kg/m³, in this case 100 kg/m³, and a micronaire per 5 grams of 3.5.

The desizing step that precedes the removal of the fibers from the specimens of manufactured products of the prior art and of the invention consists in placing them in an oven for three hours in several heating cycles, which were the following;
placing the specimens in an oven at a temperature of 250° C.;
first heating cycle at 250° C. for one hour;
second heating cycle for one hour with the temperature being increased from 250° C. to 350° C.;
third heating cycle for one hour, with the temperature being increased from 350° C. to 450° C.; and
cooling in the ambient air for half an hour.

The sample was then removed using tweezers of the hair-plucking type, tearing off a tuft of fibers. The tuft of fibers was then placed opposite a rule or graduated tape, in order to be measured.

Thus, it should be noted, as may be seen in the photographs, that the length of the fibers of the invention is short, at most 2 cm, and 1.5 cm in the case of the fiber shown here, whereas the length of the fibers of the prior art is 3 to 4 cm, or even close to 10 cm, i.e. approximately double the length.

Apart from the difference in the length of the fibers, the product of the invention illustrated in FIG. 3 (photograph corresponding to 5 cm of the specimen) shows a very homogeneous multidirectional distribution of the fibers with no “holes” unlike the product of the prior art illustrated in FIG. 4 (a photograph corresponding to 5 cm×5 cm of the specimen) in which agglomerates of fibers bonded together tend to form, which results in holes, identified by the reference T in the figure.

It has thus been demonstrated that the product of the invention has a more compact structure, resulting in an isotropic product, thereby consequently ensuring that it undergoes much less pronounced fiber deconsolidation in the tear test than a product of the prior art (FIG. 5). In fact, as shown in FIG. 5, when the specimens are torn in the direction of the arrows, the product of the prior art (specimen 1) has fibers that are no longer “bonded”, i.e. fastened together, unlike the specimen of the invention (specimen 2).

It is surprising to note that the product according to the invention exhibits better mechanical properties than the specimen according to the prior art. This is because it might seem at first sight that a specimen in which the fibers are long and entangled would withstand a higher mechanical force than a specimen with short fibers. In fact, the tear strength and compressive strength values are better in the case of the product of the invention, as we will see later in a summarizing table. This effect may be attributed to a more compact structure than shorter fibers allow.

The following tests were carried out on specimens according to the invention and according to the prior art:

The tear test is according to the EN 1607 standard. A ring-shaped specimen is sandwiched between two cylinders, one of which is fixed and the other is moved translationally at a speed of about 300 mm/min so as to pull on the specimen. A force sensor measures the force at which the specimen breaks. Two tear test are generally carried out, a first on the product obtained directly after manufacture, the second on an aged product, obtained from a product autoclaved at a temperature of 107° C. and a relative humidity of 100% for 45 minutes (called the post-autoclave strength).

The compression test is according to the EN 826 standard. It consists in applying a compressive force on the faces of a square specimen. A force sensor measures the force for which the compression of the specimen corresponds to a 10% deformation of its initial thickness.

The product of the invention is obtained using a main process and a fiberizing device that are similar to those of the prior art, to which modifications were made. These modifications prove to be important for obtaining high-quality products.

As in the prior art, the fiberizing device comprises a bottomless spinner 1, a solid-bottomed basket 2 placed inside the spinner, an annular burner 3 and a blowing ring 4, the burner and the ring surrounding the spinner.

The bottomless spinner 1 is fixed to a hub clamped onto a hollow shaft 10 that rotates about an axis X mounted so as to be vertical, the shaft being driven by a motor (not shown).

The spinner 1 has a peripheral band 11 pierced by a large number of holes 12. The holes, between 0.9 and 0.6 mm in diameter, are formed in rows that are distributed in three groups from the top down: the intermediate rows have a hole diameter smaller by at least 0.1 or 0.2 mm than the top and bottom rows.

The basket 2 with a solid bottom 20 is coupled to the spinner, being placed inside the spinner so that its opening lies opposite the free end of the hollow shaft 10 and its wall 21 is well away from the peripheral band 11.

The cylindrical wall 21 of the basket is drilled with a small number of relatively large holes 22, for example with a diameter of around 3 mm.

A stream of molten glass feeds the spinner, by passing through the hollow shaft 10, and flows into the basket 2. The molten glass, by passing through the holes 22 in the basket, is then distributed in the form of primary streams 5 directed toward the inside of the peripheral band 11, from which there are expelled through the holes 12 owing to the effect of the centrifugal force in the form of filaments 50.

The glass compositions used for the products of the invention may vary. Examples of compositions are given in patent applications EP 0 399 320 and EP 0 412 878.

As an example, one composition is the following, for which the elements are expressed in percentages by weight:

| | |
|---|---|
| SiO₂ | 65.3 |
| Al₂O₃ | 2.1 |
| Na₂O | 16.4 |
| CaO | 8.1 |
| MgO | 2.4 |
| K₂O | 0.7 |
| B₂O₃ | 4.5 |

Mention may also be made of another example of a glass composition, taken from patent application WO 00/17117, which has the advantage of an improved temperature withstand capability. The elements are expressed in percentages by weight.

| | |
|---|---|
| SiO₂ | 42.3 |
| Al₂O₃ | 23.2 |
| Fe₂O₃ | 4.9 |
| CaO | 15 |
| MgO | 0.6 |
| Na₂O | 6.1 |
| K₂O | 5.1 |
| P₂O₅ | 0.1 |

The annular burner 3 is according to the teaching of patent EP 0 189 354. It generates a gas jet, the temperature of which at the lips of the burner is between 1500 and 1650° C., preferably 1550° C.

The blowing ring 4, which constitutes the known pneumatic means for helping to channel the fibers, comprises elements for generating gas jets, these being preferably individual and divergent, joining up beneath the lowermost row of holes of the peripheral band 11. Two embodiments are preferred: a tubular annulus filled with holes into which teats are fixed, or a series of nozzles.

This pneumatic barrier thus formed slows down the fibers and possibly inflects the direction of their movement. Furthermore, when the fibers strike the sheet of cold gas, they break owing to the sufficiently large shock generated.

Unlike the prior art, the device of the invention includes no annular inductor for heating the peripheral band 11.

According to the invention, the device does include a mechanical means serving to break the fibers, which device is in the form of an annular device 6 provided with a stainless steel outer wall 60 in the form of a truncated cone flared out toward the top and turned toward the spinner 1. This device 6 is in accordance with the teaching of document WO 01/38245. Advantageously, it comprises an internal cavity 61 constituting a water-circulation cooling system in order for the wall 60 with which the fibers come into contact to remain at a sufficiently low temperature for them not to stick thereon, but rather to “rebound” and possibly breaking under the impact.

According to the invention, another modification over the prior art consists in lowering the bottom 20 of the basket 2 relative to the free end of the hollow shaft 10 so that the bottom 20 is substantially at the height of the lowest part 14 of the peripheral band 11 of the spinner, also called the band base (FIG. 7).

This lowering, or additional distancing from the upper part 16 of the spinner, is achieved for example by means of a chock 23 mechanically fixed, for example by screwing, on the one hand to the basket 2 and on the other hand to the usual suspension piece 15 fastened to the spinner 1. The chock ensures that the basket is further away from the free end of the shaft and therefore from the upper part 16 of the spinner.

This configuration allows the molten glass emanating from the holes 22 in the basket to be dispersed in the band base 14 of the spinner, thus maintaining this part at a temperature low enough not to block the lower holes 12, the glass nevertheless reaching the upper holes by the centrifugal force. Thus, the fibers expelled to the outside of the spinner are essentially free of devitrified particles or grains.

Finally, upon leaving the device of the invention, the fibers, after having struck the wall 60, are conventionally deposited in layers on a belt, after they have been sprayed with a binder beneath the spinner (the belt not being illustrated). Also not shown, being commonplace in the prior art, are the heat treatment, in particular for crosslinking the binder, and the crimping of the web according to the teaching of patent EP-133 083.

The product resulting from the attenuation using the device of the invention and the crimping operation makes it possible to obtain a fiber fineness corresponding to a micronaire per 5 grams of less than or equal to 4, especially between 2.5 and 4; in particular, a micronaire per 5 g of 3 corresponds to a mean diameter between 4 and 6 μm. The product of the invention thus has the advantage of comprising fine fibers, as may exist in the standard product of the prior art such as specimen 1, but remains better in terms of fineness than the product according to that of application WO 01/38245 for which the micronaire per 5 grams is 6.8. This fineness ensures a much softer feel and a reduction in thermal conductivity of 0.5 to 1 mW/m·K.

Table 1 below summarizes, and allows comparison of, the properties of a standard product according to the prior art, a product called LITOBAC in accordance with application WO 01/38245 and a product of the invention, these three products having a density of 100 kg m³ and a binder content relative to the glass wool of about 10% by weight. These are in particular 50 mm thick insulation panels for flat roofs that can be walked upon.

TABLE I

| | | Thermal | | | |
|---|---|---|---|---|---|
| | | conductivity in | Pre-autoclave tear | Post-autoclave tear | Compressive |
| | Micronaire | mW/m · K | strength in kPa | strength in kPa | strength in kPa |
| Standard | 3.5/5 g | 35 | 20 | 15 | 50 |
| product | | | | | |
| LITOBAC | 6.8/5 g | 36.5 | 30 | 20 | 70 |
| product | | | | | |
| Product | 3.5/5 g | 35 | 30 | 20 | 70 |
| of the | | | | | |
| invention | | | | | |

The product of the invention mentioned by way of example in Table I above was therefore obtained by a device having, as features compared with the prior art, a cooled wall off which the fibers rebound and break, and also a lowering of the bottom of the basket to a height substantially equivalent to that of the lowest part of the peripheral band of the spinner.

Alternative embodiments of the device described above also make it possible to obtain a product of the invention that has short fine fibers and an even smaller diameter than that given for the product mentioned above. In this regard, the micronaire is not expressed per 5 grams but formulated as l/mim. The fibers have a micronaire of at most 18 l/mim.

Thus, in an alternative embodiment, the lowering of the basket is not essential and is in particular omitted, and the mechanical means 6 for breaking the fibers may be rendered ancillary. The process for obtaining the fibers consists in fact in varying the pneumatic means promoting breakage of the fibers and used for attenuating the fibers, which has an influence on their fineness.

Also, the temperature and/or pressure of the burner 3 are/is regulated.

In particular, a burner temperature of at least 1500° C. is maintained and the temperature is increased depending on the temperature of the glass in order to reach temperatures of around 1600° C., or even up to 1650° C.

Supplementarily or alteratively, the pressure of the burner is adapted so that it is high enough, at least equal to 600 mm of WC and preferably about 650 mm of WC.

Furthermore, again for acting on the fineness of the fibers, it is possible to use a standard spinner, that is to say one in which the holes have a diameter of between 0.6 and 0.9 mm, but modified by increasing the number of holes over the entire periphery of the dish, therefore reducing the flow of glass ejected per hole. If a spinner has, for a certain diameter, about 26000 holes, it will be advantageous to configure a spinner of the same diameter to have 28000 or even 30000 holes.

This process variant ensures that fibers with a micronaire of at most 18 l/mim are obtained.

Table II below summarizes the properties of the two products resulting from this process variant, with a burner temperature of 1600° C. and a pressure of 650 mm of WC. In the case of the second product, the fiberizing device combines the mechanical means with the pneumatic means. These products have a density of 80 kg/m³, a binder content relative to the glass wool of about 10% by weight, and a thickness of 80 mm.

TABLE AU II

| Product of | | Thermal | Tear | Compressive |
|---|---|---|---|---|
| the | | conductivity | strength | strength |
| invention | Micronaire | in mW/m · K | in kPa | in kPa |
| Variant of the | 13 l/min | 35 | 26 | 55 |
| process | | | | |
| without | | | | |
| mechanical | | | | |
| means | | | | |
| Variant of the | 13 l/min | 35 | 29 | 61 |
| process with | | | | |
| mechanical | | | | |
| means | | | | |

It may be seen that the fibers obtained have a micronaire of 13 l/mim (mean diameter of 3 μm), accompanied by a reduction in thermal conductivity, this being at most 35 mW/m·K.

The use of the mechanical means in the case of the second product gives it performance levels, as regards tear strength and compressive strength, that are substantially higher than those for the first product.

Compared with the product of Table I, an equivalent thermal performance is obtained with a lower density, thanks to the even finer micronaire in the case of these variants, while still maintaining a high level of mechanical performance.

1. A thermal and/or acoustic insulation product based on mineral fibers, obtained by internal centrifugation and attenuation by a high-temperature gas stream and by crimping, wherein the product contains no devitrified and/or defiberized particles, the length of the fibers is at most equal to 2 cm, preferably less than 1.5 cm, and the fibers have a micronaire per 5 grams of less than or equal to 4, especially between 2.5 and 4, or a micronaire of less than or equal to 18 /min, especially between 11 and 15 /min, in particular around 12 to 13 /min.

2. The product as claimed in claim 1, wherein the product has a density at least equal to 40 kg/m³, especially between 60 and 200 kg/m³, or even equal to or greater than 80 kg/m³, in particular less than 120 kg/m³.

3. The product as claimed in claim 1, wherein the product is obtained from internal centrifugation by flow of molten glass in a basket provided with holes from which primary streams are expelled toward the peripheral band of a spinner, which spinner also has holes from which filaments are expelled, these expelled filaments being attenuated by high-temperature gases emitted from the outlet of a burner at a temperature of at least 1500° C., preferably at least 1600° C. and especially between 1500 and 1650° C.

4. The product as claimed in claim 1, wherein the product is obtained by attenuating filaments, these being expelled from a spinner, in a high-temperature gas stream that is emitted from the outlet of a burner at a pressure of at least 600 mm of WC, preferably in the region of 650 mm of WC.

5. The product as claimed in claim 1, wherein the product is obtained by means of internal centrifugation by flow of molten glass in a basket provided with holes from which primary streams are expelled toward the peripheral band of a spinner, which also has holes from which filaments are expelled, the bottom of the basket being substantially at the height of the lowest part of the spinner.

6. The product as claimed in claim 3, wherein the product is obtained from 6 filaments expelled from the spinner and channeled using a pneumatic means, of the gas jet type, so as to produce fibers which in turn are also channeled and adjusted lengthwise using a mechanical means, of the wall type, which is struck by the fibers.

7. The product as claimed in claim 1, wherein the mineral fibers are obtained from the following glass composition (in proportions by weight):

| SiO₂ | 57 to 70% |
|---|---|
| Al₂O₃ | 0 to 5% |
| CaO | 5 to 10% |
| MgO | 0 to 5% |
| Na₂O + K₂O | 13 to 18% |
| B₂O₃ | 2 to 12% |
| F | 0 to 1.5% |
| P₂O₅ | 0 to 4% |
| Impurities | <2% |

and contains more than 0.1% by weight of phosphorus pentoxide when the weight percentage of alumina is equal to or greater than 1%.

8. The product as claimed in claim 1, wherein the mineral fibers are obtained from the following glass composition in mol %:

| | |
|---|---|
| SiO₂ | 55-70 |
| B₂O₃ | 0-5 |
| Al₂O₃ | 0-3 |
| TiO₂ | 0-6 |
| Iron oxides | 0-2 |
| MgO | 0-5 |
| CaO | 8-24 |
| Na₂O | 10-20 |
| K₂O | 0-5 |
| Fluoride | 0-2 |

9. The product as claimed in claim 1, wherein the mineral fibers are obtained from the following glass composition (in proportions by weight), the alumina content preferably being greater than or equal to 16 wt %:

| | |
|---|---|
| SiO₂ | 35-60% |
| Al₂O₃ | 12-27% |
| CaO | 0-35% |
| MgO | 0-30%, |
| Na₂O | 0-17% |
| K₂O | 0-17% |
| R₂O (Na₂O + K₂O) | 10-17%, |
| P₂O₅ | 0-5% |
| Fe₂O₃ | 0-20% |
| B₂O₃ | 0-8% |
| TiO₂ | 0-3% |

10. The product as claimed in claim 1, wherein the product is used to manufacture roof panels with a density of between 80 and 150 kg/m³, a binder content of around 10% and having a tear strength after ageing of at least 20 kPa and a compressive strength of about 70 kPa for a thickness of about 50 mm or at least 55 kPa for a thickness of about 80 mm, and also a thermal conductivity of at most 35 mW/m·K.

11. A device for forming mineral fibers by internal centrifugation, comprising:
a spinner capable of rotating about an axis X, especially a vertical axis, and the peripheral band of which is drilled with a number of holes;
a basket with associated bottom inside the spinner;
a high-temperature gas attenuation means in the form of an annular burner);
a pneumatic means for channeling/adjusting the dimensions of the fibers, in the form of a blowing ring;
wherein the device includes a mechanical means comprising a wall placed around the spinner, opposite at least its peripheral band, and the bottom of the basket is substantially at the height of the lowest part of the peripheral band of the spinner using means for lowering the basket or distancing it from the upper part of the spinner.

12. The device as claimed in claim 11, wherein the lowering or distancing means consisting of a chock associated on the one hand, with the basket and, on the other hand, with the upper part of the spinner.

13. The device as claimed in claim 11, wherein the wall is cooled and is at least partly cylindrical or in the form of a truncated cone preferably flared out at the top.

14. The device as claimed in claim 11, wherein the temperature of the burner is at least 1500° C., preferably at least 1600° C.

15. The device as claimed in claim 11, wherein the pressure of the burner is at least equal to 600 mm of WC, preferably about 650 mm of WC.

16. A process for forming a product based on mineral fibers as claimed in claim 1, by internal centrifugation by means of a spinner in which molten glass flows and from which filaments are expelled, by high temperature gas attenuation by means of an attenuating gas stream emitted by a burner and through which the filaments are converted into fibers, and by crimping, wherein the temperature of the burner and/or its pressure are/is adjusted according to the temperature of the molten glass.

17. The process as claimed in claim 16, wherein the temperature of the burner is at least 1500° C., preferably at least 1600° C.

18. The process as claimed in claim 16, wherein the pressure of the burner is at least 600 mm of WC, preferably about 650 mm of WC.

19. The process as claimed in claim 16, wherein the fibers are channeled using a pneumatic means, of the gas jet type, and are adjusted lengthwise using a mechanical means, of the wall type, which are struck by the fibers.

20. The process as claimed in claim 16, wherein the filaments expelled from the spinner are obtained from a spinner, the bottom of the basket of which has been lowered so as to be approximately at the height of the lowest part of the spinner.

21. The process as claimed in claim 16, wherein the number of holes in the spinner per unit area is increased.

22. The device as claimed in claim 11, wherein the device is utilized for manufacturing thermal and/or acoustic insulation products.

23. The process as claimed in claim 16, wherein the process is utilized for manufacturing thermal and/or acoustic insulation products.
